(19) United States
(12) Patent Application Publication
(10) Pub. No.: US 2003/0144453 A1
(43) Pub. Date: Jul. 31, 2003

(54) Process for the production of polyurethanes and/or polyureas using amine-N-oxide catalysts and compounds containing amine-N-oxides

(76) Inventors: Erich Frauendorfer, Emden (DE); Werner Klockemann, Buchholz (DE)

Correspondence Address: Alan B. Clement, HEDMAN & COSTIGAN, P.C., 1185 Avenue of the Americas, New York, NY, 10036, US

(21) Appl. No.: 10/052,228

(22) Filed: Jan. 18, 2002

(51) Int. Cl. C08G 18/00

(52) U.S. Cl. 528/44

(57) ABSTRACT

The subject of the invention is a process for the production of polyurethanes and/or polyureas using amine oxides as catalysts and a composition containing an amine oxide, a polyisocyanate with at least two isocyanate groups and a compound with at least two reactive hydrogen atoms.

The subject of the invention is a process for the production of polyurethanes and/or polyureas using amine oxides as a catalyst and a compound containing an amine oxide, a polyisocyanate with at least two isocyanate groups and a compound with at least two reactive hydrogen atoms.

Designated as polyurethanes (PUR) are polymers with very different compositions. What all polyurethanes have is common is that they are produced according to the diisocyanate-polyaddition process and show urethane groups as a characteristic link. The share of the urethane groups as compared with other groups linking the monomer units can, however, be of subordinate importance. Besides the urethane bond, among others, urea, amide, biuret, acyl urea, uretoninin, isocyanurate and carbodiimide bonds can be formed by the isocyanate reaction.

In many industrially significant polyurethane plastics, the urethane groups link polyalkylene ether or polyester sequences which, in turn, can show molecular weights of 150 to 8,000 g/mol.

The large variety of possible links is not due only to the reactivity of the isocyanate bond, but also to the large number of different monomers reactive to the isocyanate group. Moreover, with regard to the functionality, different monomers can be used alongside each other at the same time. The most commonly used monomers besides the diisocyanates show alcohol, carbonic acid and/or amine groups. Besides them, the reaction of the isocyanate group with itself to form polyisocyanurates and with water plays an important part.

The NCO group is very sensitive to catalysts of the most varied types, the extent of reaction acceleration depending on the type of reaction is very varied. Both Lewis bases and also Lewis acids are effective catalysts. The most important Lewis bases are tertiary amines with the most varied structures. The most important Lewis acids acting as catalysts are tin-organic metal compounds. The catalysts are often used as a system, i.e. as a combination of several catalysts, for example of a Lewis base with a Lewis acid. The catalyst/catalyst system is used for the acceleration of two and sometimes three main reactions which proceed simultaneously and often in competition with each other.

One of these reactions (chain extension reaction) is the chain-lengthening isocyanate/hydroxyl reaction in which a molecule containing hydroxyl reacts with a molecule containing isocyanate, forming a urethane. In this reaction a secondary nitrogen atom is produced in the urethane groups. If, beside the hydroxyl groups also other reactive groups, showing hydrogen, such as amine groups, are present, also other chemical linkages (e.g. urea groups) contribute to the formation of the chain.

A further type of reaction is the cross-linking isocyanate/urethane reaction (cross-linking reaction or also gel reaction), in which a molecule containing isocyanate reacts with the urethane group which contains a secondary nitrogen atom.

The further reaction important for many polyurethanes with cellular structure is the isocyanate/water reaction in which a molecule with an isocyanate terminal group is extended, forming a urea group, and carbon dioxide is produced. The gas released acts as a blowing agent to expand the foam or to support the expansion of the foam. This reaction is also designated a blowing or expansion reaction. As a result of the isocyanate/water reaction ‘in situ’, either the whole gas or only part of it is produced for the foaming reaction.

All three reactions are to proceed at speeds adjusted to each other in an optimal way. In this context it is often desired that the extent of the overall activity in relation to one of the above-mentioned types of reactions is phase-shifted, so that a good foam structure is obtained. If the carbon dioxide development proceeds too quickly in comparison to the chain extension, the foam collapses. If the chain extension in comparison to the carbon dioxide development proceeds too quickly, the height of rise of the foam is limited. In the absence of adequate cross-linking (gel reaction), the foam is not stable.

Depending on the desired formation of the polyurethane plastics (soft foamed plastic, block foamed plastics, coating, adhesive, sealant, etc.), different behavior can be desired. For soft foamed plastics, for instance, a strong cross-linking is undesirable in the first foam formation phase, because this, due to the high viscosity and/or high strength of the foam, prevents an adequate risings height of the foam and a formation of a foam of a low density.

Tertiary amines are well known as catalysts for all three reaction types, the tertiary amines being able to show, depending on the structure, a very different behavior as compared with chain extension reaction, cross-linking reaction, blowing reaction. A few of the tertiary amines, are, for example, essentially effective catalysts exclusively for the isocyanate/water reaction (e.g. dimorpholinodiethyl ether). Many tertiary amines are, however, not good catalysts for the chain extension reaction, which is why prepolymers are often used when these catalysts are applied.

The production of polyurethane foamed plastics by the conversion of higher-molecular, preferably polyester or polyetheresterpolyols and, if necessary, chain extension and/or cross-linking agents with organic and/or modified organic polyisocyanates is well known and is described in numerous patent and literature publications. Polyurethane foamed plastics are used in particular for furniture, mattresses, couches and upholstery.

It is also the task of the present invention to make available a catalyst which makes it possible to produce low-emission and/or no-emission polyurethanes and/or to eliminate the very troublesome odor nuisance of the amines during the work process and/or to reduce it quite considerably. Low-emission and/or no-emission PU-foamed plastics in the sense of the invention are such as show both very low fogging values (precipitation of organic compounds on surfaces) and also very low VOC values (volatile organic compounds) i.e. a very low tendency to release gaseous organic compounds.

The increasing sensitization of the consumers with regard to avoidable contamination by chemicals and the ever growing group of persons with allergic reactions to chemicals in the air in buildings requires, as far as possible, a comprehensive reduction of all volatile components in polyurethane plastics. The disadvantage of the well-known amine catalysts for polyurethane plastics is that these frequently develop a markedly perceptible odor, while this is in the case of the catalysts according to the invention, not the case due to the low volatility.

A further disadvantage of well known tertiary amine catalysts is that tip up their insertion—if they are inserted—are frequently of high volatility and that the balance between adequate fluidity and fast final hardening is often difficult to adjust. In applications, in which a filling of a cavity by the foam is desired, for example in refrigerator applications, low fluidity and excessively fast hardening in relation to the low fluidity can lead to inadequate filling of the cavities.

These and other tasks are, according to the invention, solved by a process for the production of polyurethanes and/or polyureas by conversion of

(A) compounds containing at least two isocyanate groups with

(B) compounds containing at least two reactive hydrogen atoms in the presence of one or more catalysts, at least one of the catalysts

(C) being an amine oxide and/or containing an amine oxide group; and a composition containing the components (A) to (C).

Preferred embodiments are the subject of the sub-claims and/or explained below. The starting components which can be used in the process in accordance with the invention are explained by examples below under (1) to (8).

(1) Polyisocyanates (Compounds Containing at Least Two Isocyanate Groups)

Suitable as polyisocyanates are the well known organic, e.g. aliphatic, cycloaliphatic, arylaliphatic, cycloaliphatic/aromatic and preferentially aromatic isocyanates with at least two isocyanate groups.

The usual representatives of aliphatic polyisocyanates are, for example, 1,6-diisocyanatohexane, 3,5,5-trimethyl-1-isocyanato-3-isocyanato-methyl-cyclohexane, 4,4′-diisocyanato-dicyclohexylmethane, trimeric hexanediisocyanate and 2,6-diisocanato-hexanoic acid methyl ester. The usual aromatic polyisocyanates are 2,4-diisocyanato-toluol, 1,5-diisocyanato-naphthalene and 4,4′-diisocyanatodiphenyl methane.

In detail, the following may be mentioned as examples of aromatic polyisocyanates: 4,4 and 2,4-diphenylmethane diisocyanate (MDI), mixtures of MDI isomers and polyphenyl/polymethylene/polyisocyanates, 2,4 and 2,6-toluylene-diisocyanate,(TDI) as well as the corresponding commercially available isomer mixtures.

Also suitable are so-called modified multivalent isocyanates, i.e. products which are obtained by chemical conversion of organic compounds with polyisocyanates. Examples which can be mentioned are diisocyanates and/or polyisocyanates containing ester, urea, biuret, allophanate, isocyanurate and preferentially carbodiimide, uretonimin and/or urethane groups.

In detail, examples which can be considered: prepolymers containing urethane groups with an NCO content of 2 to 16% by weight or quasi-prepolymers prepolymers with an NCO content of 16 to 32% by weight which can be produced by conversion of diols, oxalkylglycols and/or polyoxyalkylene glycols with polyisocyanates. The polyisocyanate is preferentially a liquid at room temperature.

(2) Compounds With at Least Two Reactive Hydrogen Atoms

For this all compounds can be considered, as a matter of principle, which in relation to the isocyanate group show at least two reactive hydrogen atoms. These are, for example, organic compounds with amine (N—H), hydroxy (O—H) and/or acid (C(═O)—O—H) groups. The H-functional, preferentially higher-molecular compounds usual for the production of polyurethanes are polyether and polyester polyols, but also polythioether polyols, polyester amides, polyacetals containing hydroxile groups and aliphatic polycarbonates containing hydroxile groups or mixtures of at least two of the compounds mentioned. Particularly suitable are polyether polyols, such as polypropylene oxide or polyethylene oxide and/or their copolymerides which are produced with the help of difunctional alcohols or multi-functional alcohols as starter molecules. The polyether component preferentially shows a molecular weight between 150 and 8,000 g/mol, in particular 300 and 3,000 g/mol and a functionality of 1.5 to 3.

For the production of the polyesters used according to the invention, difunctional and trifunctional polyols with dicarboxylic acids and/or their anhydrides are polycondensed. Suitable polyols are, for example, ethylene glycol, 2-propane diol, 1,4-butane diol, 1,6-hexane diol, glycerol, trimethylol propane, pentaerythrite, glycerol and hexantriol. Suitable dicarboxylic acids and/or anhydrides are succinic acid, adipic acid, phthalic acid and isophthalic acid. The polyesters preferentially show a molecular weight of between 300 and 3,000 g/mol and a comparatively high hydroxy value with a comparatively low acid value.

Also suitable are mixtures of polyether polyols and polyether polyamines. Suitable polyester polyols can, for example, be produced from organic dicarboxylic acids with 2 to 12 carbon atoms, and multivalent alcohols with 2 to 12 carbon atoms.

Ranking among the polyester amides which can be used are, for example, the predominantly linear condensates gained from multivalent, saturated and/or unsaturated carbonic acids and/or their anhydrides and multivalent saturated and/or unsaturated aminoalcohols or mixtures of multivalent alcohols and amino alcohols and/or polyamines.

Urea groups can be introduced to the polyurethanes produced in accordance with the invention by the use of water or diamines. Ethylene diamine, 1,2-propylene diamine, diaminocyclohexane or piperizine act, for example, as chain extenders or cross-linking agents. Polyurethane prepolymers with amine terminal groups are more reactive than those with a hydroxy group so that these polyurethanes harden more quickly. Likewise compounds with polymercapto groups can be used.

(3) Low-molecular Chain Extension and/or Cross-linking Agents (Optional)

As such agents polyfunctional, in particular difunctional and trifunctional compounds with molecular weights from 18 to about 400 g/mol, preferentially from 62 to roughly 300 g/mol can be considered Examples of those used are dialkanolamines and/or trialkanolamines, such as diethanolamine and triethanolamine, aliphatic diols and/or triols with 2 to 6 carbon atoms in the alkene residue, such as ethane, 1,4-butane, 1,5-pentane, 1,6-hexane diol, glycerol and/or trimethylol propane, water and low-molecular ethoxylation and/or propoxylation products, produced from the above-mentioned dialkanol amines, trialkanol amines, diols and/or triols as well as aliphatic and/or aromatic diamines.

Preferentially used are dialkanol amines, diols and/or triols and in particular ethane diol, butane diol-1,4, hexane diol-1,6, diethanolamine, trimethylolpropane, pentaerythrite, glycerol or hexane triol or mixtures of at least two of the above-mentioned compounds. But also some of the catalysts described below used in accordance with the invention can, if inserted, act as cross-linking agents due to their several groups which are reactive to isocyanates.

(4) Blowing Agents (Optional)

In the area of polyurethane foams, blowing agents acting physically are used. Particularly suitable are substances which are inert to the organic, possibly modified polyisocyanates and show boiling points above 20° C., preferentially above 40° C., at atmospheric pressure. Examples of such preferentially usable substances are low-boiling hydrocarbons, such as for example n/i-butane, pentane, cyclopentane, ethers such as dimethyl ether and halogenated hydrocarbons such as R134a and R152a, solution or complex-bound carbon dioxide or ‘reactive carbon dioxide’ (e.g. carbamide compounds).

Included among the blowing agents that are used for the production of polyurethane-foamed plastics is also water or, related to PU assembly foams, humidity which reacts with isocyanate groups forming carbon dioxide as a blowing agent.

(5) Flame Proofing Agent (Optional)

To increase the flame resistance with simultaneous reduction of the flue-gas density in the event of fire as flame-proofing agents for example halogenated, organic compounds preferentially phosphoric esters are used in effective quantities. Moreover, as flame-proofing agents halogenated, mostly brominated, aromatic polyester polyols, melamine derivatives, starch, phosphorus compounds, such as tricresyl phosphate, insertable phosphoric compounds and inorganic salts and preferentially modified or non-modified ammonium polyphosphates are used.

(6) Stabilizers (Optional)

To avoid collapses and to form a fine, homogeneous cellular structure foam stabilizers are used. These are surface-active substances, mainly polyether-modified polysiloxanes, which are used for supporting the homogenization of the starting materials and, if necessary, are also suitable for regulating the cellular structure of the foamed plastics. Ones that may be named are silicone oils such as mixed siloxane/oxyalkylene polymerides and other organopolysiloxanes, ox(C2 to C4) alkylated (C1 to C18) alkylphenols amd ox(C2 to C4)alkylated (C8 to C24) fatty alcohols.

(7) Further Auxiliary Agents and/or Additives (Optional)

Further auxiliary agents and/or additives can be incorporated into the reaction mixture, if necessary. For example ones that may be named are surface-active substances, pore regulators, substances acting as fungistats and bacteriostats, dyes, pigments and fillers, plasticizers, desiccants, fillers, latent hardeners, adhesion improvers. Further possible additives are hydrolysis stabilizers, oxidation stabilizers, UV stabilizers, flame-proofing agents or also dyes, preferentially in the form of dye pastes.

(8) Further Catalysts (Optional)

The catalysts according to the invention can, at least related to the entire production process, be used in combination with other polyurethane catalysts. These can be basic polyurethane catalysts, for example tertiary amines, such as dimethylbenzylamine, dicyclohexylmethylamine, dimethylcyclohexylamine, bi-(dimethylaminopropyl)ether, N-methyl and/or N-ethylmorpholine, N-dimethylaminoethylpiperidine, 1,2-dimethylimidazol, N,N,N′,N′,-tetra(C1 to C6-alkyl)ethylenediamine, dimethylaminoethanol, 2-(N,N-dimethylaminoethoxy)ethanol, tri-(dialkylaminoalkyl)-hexahydrotriazine, di-(4-dimethylaminocyclohexyl)-methane, bi-(dimethylamino-ethyl) ether, tetramethylguanidine and bi-dimethylaminomethylphenol and in particular triethylenediamine (1,4-diazabicyclo[2,2,2]octane).

Imidazole, N-alkylimidazoles, in particular N-propylimidazole, bidimethylamino(C1 to C6-) alkylether, dimorpholinodialkylether, in particular bidimethylaminodiethy ether, dimethyl-2-(2-aminoethoxy)(C1- to C6-)alkanols, in particular dimethyl-2-(2-aminoethoxy)ethanol, N,N,N′,N′,N′-pentamethyldipropylentriamine, N,N,N′,N′,N′-penta-methyldiethylenetriamine, N′,N′-dimethylaminoethyl-N-methylalkonol-amines, in particular N′,N′-dimethylaminoethyl-N-methylethanolamine, N,N,N′-trimethyl-N′-hydroxyethyl-bi(aminoalkyl)ether, in particular N,N,N′-trimethyl-N′-hydroxyethyl-bi(aminoethyl)ether, N,N′-bi(3-dimethylaminopropyl)amino-alkanols, in particular N,N′-bi(3dimethylaminopropyl)amino-2-propanol, 1,3-bi(dimethylamino)-alkanols in particular 1,3-bi(dimethylamino)-2-propanol, N,N,N′,N′,N″-pentamethyldiethylenetriamine and N,N,N′,N′-tetramethyliminobipropylamine.

Ones which can also be mentioned are N-(2-hydroxypropyl)imidazole, N-(2-hydroxethyl) imidazole, tri(3-dimethylamino)propylamines, 1,3,5-tri(3-dimethylaminopropyl)hexahydrotriazine, bi-(dimethylaminopropyl)amino-2-propanol, dimethylaminopropyl-dipropanolamine, N-methyldicyclohexylamine, 2,4,6-tri(dimethylaminomethyl)phenol, N,N-dimethylpiperazine, 1-dimethylaminoethyl-4-methylpiperazine, N,N-dimethylaminoethyl-N′-methylaminoethanol, N-(3-aminopropyl)imidazole and bi-(dimethylaminopropyl)amino-2-propanol.

Also suitable are their ammonium salts, e.g. as tertiary amines blocked with organic acids.

However, also suitable are ferrous chloride, zinc chloride, potassium acetate or, in particular, metal salts of organic compounds, in particular of bismuth and tin, such as dialkyltindicarbonic acid esters (e.g. dibutyltin dilaurate or tin diethylhexoate), potassium octoates, lead octoate, tin dioctoate, dibutyltin bi-dodecylmercaptite, dibutyltin mercaptite and lead phenylethyldithiocarbaminate.

The catalysts used in accordance with the invention can be used together with the tertiary amines or organo-metallic compounds (metal salts of organic compounds).

Within the scope of the invention, the polyurethanes can be produced according to different production methods. The polyurethane foamed plastics can be produced according to the one-shot process by the mixing of two components. For this the two components must only be intensively mixed before production of the polyurethanes. The reaction mixtures can be foamed in open or closed form tools as well as to form block foamed plastics. According to the one-shot process, polyurethanes, if necessary also in the presence of solvents, are produced in the presence of all of the reaction components.

From these one distinguishes the prepolymer process. Polyurethane prepolymers are intermediate stages of the isocyanate polyaddition. A distinction is made between NCO prepolymers with terminal NCO groups and hydroxy prepolymers. The NCO prepolymers have a particular significance as they can be hardened with a large number of active compounds containing hydrogen. They are obtained by conversion of dihydroxy and/or polyhydroxy compounds with a molar excess of diisocyanate and/or polyisocyanate. These mixtures can still contain a considerable percentage of the monomeric isocyanate.

Two-component systems mostly consist of a polyhydroxy component—which can already be extended by a diisocyanate to form a prepolymer with terminal OH groups—as the main component and an isocyanate adduct as a cross-linking agent. Two-component systems are preferred.

Amino Oxide Catalysts

The subject of the catalysts used according to the invention are amine oxides, more precisely spoken amine-N-oxides. Amine oxides can be obtained by a reaction of organic tertiary amines with oxygen and peroxide compounds. These contain the group —N—O which shows a polar bond (—N⁺—O⁻).

Amine oxides are in themselves known and are used as tensides in detergents and in hair treatment preparations.

Particularly preferentially, the amine oxide at least shows a hydrocarbon residue with β-hydrogen atom. The amine oxide can, for example, be represented by this following general formula:

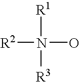

in which R¹, R² and R³ stand independently of each other for a linear or branched hydrocarbon residue with 1 to 22, preferably 2 to 8, carbon atoms and particularly preferentially for ethyl, propyl or butyl. It is likewise possible that the residues R¹, R² and/or R³ are part of one or more cyclic residues. Suitable compounds are, for example:

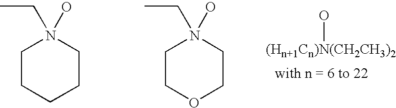

The hydrocarbon residue can, for its part, carry heteroatoms such as nitrogen or oxygen or sulfur, for example in the form of hydroxy groups, immine, and/or amine groups or ether groups. Moreover, the amine oxide can carry one or more amine oxide groups. Examples of these are the amine oxides of the tertiary amines mentioned above under (8), tri(3-diethylaminopropyl)amine-N-oxide or the compounds shown below.

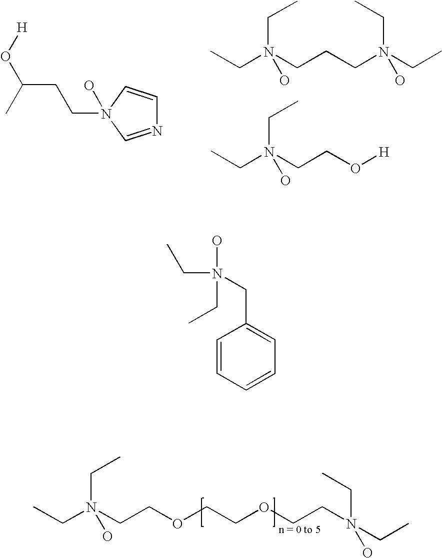

It is also possible for amine oxide to carry other catalytically active groups such as a further tertiary amine group. As an example such a compound is shown below.

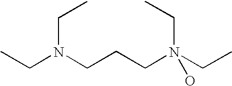

Such compounds can be easily obtained from the appropriate tertiary diamines by partial oxidation with oxygen and/or peroxide compounds such as hydrogen peroxide. Further amine oxides and/or their production are disclosed in Hauben-Weyl, part 1, volume E16a, p. 404-420 and in U.S. Pat. No. 3,503,700, the contents of which are also hereby made a subject of this application.

The amine oxide is mostly contained 0.01 to 5% by weight, preferentially at 0.01 to 2% by wt., particularly preferentially at 0.05 to 1% by wt. in the composition, based on the quantity of compound with reactive hydrogen atoms used. The amine oxide is preferentially used in a dissolved form. Solvents can be water, in particular for PU-2 component foams or on the other hand dihydroxyalkanes, glycol ethers, 5-hydroxy-1,3-dioxane (CAS No.=4740-78-7), 4-hydroxymethyl-1,3-dioxolane (the mixture of which is called glycerolformal), in particular for formulations not containing water.

Particularly preferred is the amine oxide selected from the group consisting of triethylamine-N-oxide, N-ethylmorpholinoxide, N-methylmorpholinoxide, diethyloctyl-amine and diethylcyclohexylamine-N-oxide.

The amine oxides used according to the invention therefore prove to be interesting catalysts, because they—as far as they eliminate an alkyl residue at high temperatures—can form an amine derivative which is reactive to the isocyanate group and is insertable.

Without wanting to be tied to the theory, it is assumed that by way of the hydro(dialkyloxidoammonio)elimination (Cope elimination) a five-membered transition condition is formed which, with the bond shift of a β-hydrogen atom and bond breakage of the N—C bond, eliminates one of the alkyl residues in the form of an olefin, forming an (N)-hydroxyl-(N)-dialkylamine derivative.

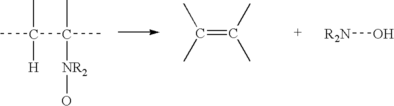

The (N)-hydroxyl-(N)-dialkylamine shows a hydrogen atom reactive to the isocyanate compound and is thus effectively inserted into the polymer matrix of the polyurethane and/or polyurea.

The decomposition is as a rule thermally initiated, the temperature being decisively influenced by the structure of the amine oxide. Thus the decomposition of some amine oxides occurs, for example, only at temperatures of 130 to 150° C. This applies, for example, to N-ethylmorpholine-N-oxide.

The oxide of the N-diethylcyclohexalamine eliminates, on the other hand, ethene already at temperatures above 50° C. The hydroxyl amine produced in each case can react with isocyanate groups not yet converted and is thus effectively inserted into the PUR plastic. The olefin liberated can escape, the quantity released being low due to the low input quantity.

The amine oxides with more than one amine oxide group used according to the invention act as chain extension agents (at least 2 amine oxide groups) or as cross-linking agents (at least 3 amine oxide groups). This can be systematically used for the physical properties, e.g. by means of this the hydrolysis sensitivity of the polyurethane plastics can be reduced. It can, moreover, be interesting to use an amine oxide with more than one amine oxide group as catalysts, in order, in the course of the reaction, to achieve a late and systematic final hardening.

The polyurethanes or polyureas used according to the invention can be used to produce soft foams, hard foams, adhesives and elastomers. Particularly advantageous is the use for the production of polyurethanes which are used in areas in which low fogging values are required, such as in the automobile interior, in seat or couch upholstery or for textile finishing.

The catalyst according to the invention shows, in comparison to the well known PUR catalysts, a number of advantages. Surprisingly the hardened PUR plastics are odorless and, unlike amine-catalyzed plastics, show no unpleasant odor. Furthermore, for the production of PUR foams the pressure build-up during the foaming of the foam is surprisingly more moderate and the rising height is greater compared to the use of tertiary amines as catalysts.

For the characterization of the foam formed usually a height of rise or rising profile measurement is carried out. In this case, in a suitable vessel the expansion behavior of a foam sample as a change in height is measured and a starting time as well as a rising time are determined. The starting time is, in this case, equated with the beginning of the reaction of hydroxyl group and isocyanate, while the rising time is the period required up to the reaching of the maximum rising height.

Before the hardening process of the PUR plastic is concluded, the foam is, mainly due to the blowing reaction, exposed to an expansion pressure, as stable cell walls prevent the gas forming from escaping. The pressure forces occurring can be so great that they lead to the destruction of the component to be coated with foam or filled with foam. These pressure forces are usually measured as the rising pressure.

The polyurethane-foamed plastics according to the invention are characterized by the use of certain catalysts. For the production of the polyurethane-foamed plastics according to the invention, the starting components (1) to (2) are used and, if necessary, the chain expansion and/or cross-linking agents (3) in the presence of blowing agents (4), and, if necessary, flame-proofing agents (5) as well as further auxiliary agents and/or additives ((6) to (8)),

The conversion is carried out preferentially at temperatures of 0 to 100° C., preferentially 45 to 80° C., such quantity ratios being brought to reaction that per NCO group 0.5 to 2, preferentially 0.8 to 1.3 and in particular approximately 1 reactive hydrogen atom bound to the starting components (2) and, if necessary, are present and, as far as water is used as a blowing agent, the molecular ratio of water equivalent to NCO group equivalent is 0.5 to 5:1, preferentially 0.7 to 0.95:1.

With the catalysts according to the invention, both soft elastic, semi-flexible foamed plastics and integral foam plastics can be produced. Preferred are PU soft-foamed plastics which can be produced as block or form soft foams for all of the usual applications, in particular block soft foams for the upholstery area, in particular mattresses, for sound proofing, for interior trim of automobiles and for the production of laminates. Also preferred are PUR adhesives and PUR elastomers.

The invention is explained in more detail in the following embodiments:

Synthesis of N-ethylmorpholine-N-oxide

100 g N-ethylmorpholine was added to 100 ml of methanol. 101 ml of 35% H₂O₂ was slowly added to this solution. In the process the temperature was not allowed to rise above, 60° C. After the completion of the addition of H₂O₂, the temperature of the mixture was maintained at 50 to 60° C., until the amine odor disappeared. It was allowed to cool down and then a small quantity of platinum on activated carbon (5%) was added in order to eliminate the H₂O₂ to surplus. After the termination of the oxygen development, filtration was then carried out through a pleated filter. The methanol was withdrawn through the rotary evaporator. The clear, colorless solution left behind was concentrated by evaporation at 50° C. under vacuum up to constant weight. 108 g of N-ethylmorpholine-N-oxide hydrate was obtained as oil which solidified some time after cooling-down. 94% yield based on the N-ethylmorpholine.

Production of Polyurethane Foams Using N-ethylmorpholine Oxide and/or Dimethylcyclohexylamine.

For the production of polyurethane foam (hard foam) the following components are added together:

TABLE 1

| Polyol blend: | Parts based on weight | |
|---|---|---|
| Caradol ® KO 585-01 (polyoxyalkylenepolyol, | 70 | parts |
| Huntsman) | | |
| TR 310 (trifunctional castor polyol) | 30 | parts |
| TCPP (trichlorpropyl phosphate) | 7 | parts |
| Stabilizer PC Stab ® SN 59 (nitroil) | 1.5 | parts |
| Water | 1.7 | parts |
| 110 g blend of the above components | | |
| Blowing agent pentane (= 14 g) | 11 | parts |
| Catalyst: (DMCHA/EMO) | 1 | part/0.6 parts |
| Isocyanate Caradate ® 30 (MDI, Huntsman) | 188 | parts |

As catalysts 0.6 parts of N-ethylmorpholine-N-oxide (EMO) and/or as a comparative test dimethylcyclohexylamine (DMCHA, 1 part) were used.

Polyol components, blowing agents, water, TCPP, silicon compound (SN 59) and catalyst were pre-mixed in a cardboard vessel and at an agitator speed of 3,000 rpm. This was followed by the addition of the isocyanate, stirring being continued briefly (approx. 12 sec).

The foam produced is cut up after 2 h of foaming and assessed visually. With regard to the grain sizes and the bubble distribution, the foam visually corresponds to the foams produced with amine catalysts.

The freely rising foam was produced in a cardboard vessel with the dimensions 200×200×200 mm. During the foam formation process the cream time, gel time and tack-free time were measured by means of a Tech DAPS 290 F device for determining the rising rate. The rising height was determined by ultrasound, the temperature by means of thermocouples.

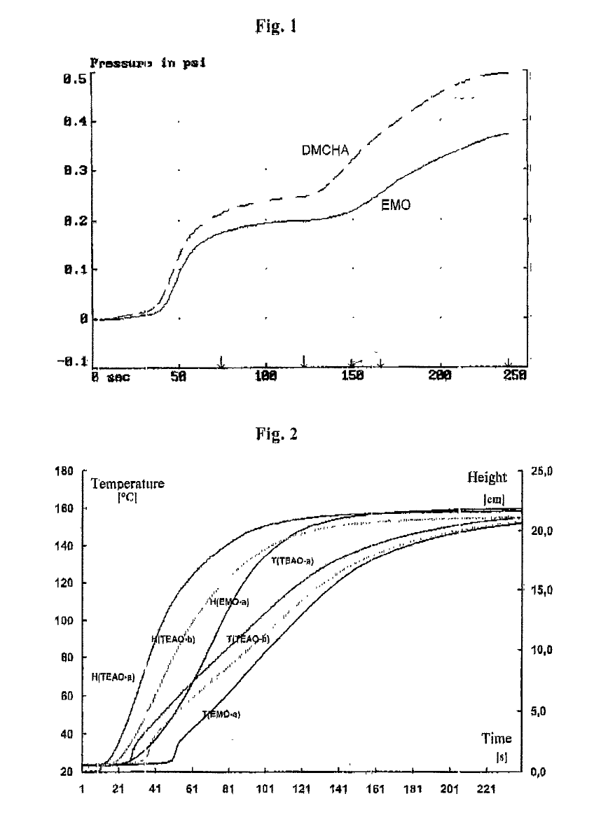

The results of the measurements are compiled in Table 2. The measuring graphs are plotted in FIG. 1 (pressure in psi over time in sec).

TABLE 2

| Catalyst | | EMO | DMCHA |
|---|---|---|---|
| Rising height | [mm] | 212.4 | 201.4 |
| Rising time | [s] | 172.4 | 143.1 |
| Shrinkage | [%] | 0.8 | 0.9 |
| Max. temperature | [° C.] | 154.3 | 155.0 |
| at | [s] | 442.5 | 367.9 |

It was shown that the reaction with the catalyst EMO according to the invention proceeds with a time lack with a markedly lower input quantity as compared with the reaction with DMCHA, and that a longer reaction time is achieved. Nevertheless, surprisingly a higher foam yield is to be observed. Converted to an 8 l form this would, with the same input quantity of PUR prepolymer, mean an additional foam quantity of 300-400 ml. The tack-free times are of a comparable order of magnitude.

Moreover, if the catalysts according to the invention are used, a lower pressure build-up (rising pressure) is observed (FIG. 1). For example, after 239 sec for the use of N-ethylmorpholine-N-oxide (EMO) a pressure build-tip of 2.56 kPa (0.371 psi) was observed, at a maximum pressure build-up rate of 17.2 Pa/s (0.0025 psi/s), achieved after 166 sec. While the catalyst dimethylcyclohexylamine (DMCHA) yielded a pressure of 3.42 kPa (0.496 psi) at a maximum pressure build-up rate of 24.8 Pa/s (0.0036 psi/s), after 149 sec. The measurements were carried out with the device FPM 2 produced by the company Format Messtechnik GmbH.

Production of a Polyurethane Foam Using Triethylamine Oxide

A PUR foam was produced in accordance with the composition shown in Table 1, as a catalyst different quantities of triethylamine-N-oxide being used. The rising height in cm (H) and the temperature curve (T) in ° C. were plotted over the time in sec and are shown in FIG. 2. The catalysts used were:

| | | |
|---|---|---|
| (1a) Triethylamine-N-oxide | (TEAO-a) | 0.83 parts |
| (1b) Triethylamine-N-oxide | (TEAO-b) | 0.58 parts |
| (2a) N-ethylmorpholine oxide | (EMO-a) | 0.6 parts |

It was shown that both catalysts in fact have roughly identically high rising heights, but that the catalyst N-ethylmorpholine oxide acts with a time lag and the reaction mixture using N-ethylmorpholine oxide with the same reaction time develops less heat. The catalyst triethylamine-N-oxide is, even with a lower input quantity, more reactive than N-ethylmorpholine oxide or dimethylcyclohexylamine

1. Process for the production of polyurethanes and/or polyureas by the conversion of
(A) compounds containing at least two isocyanate groups with
(B) compounds containing at least two reactive hydrogen atoms in the presence of one or more catalysts, at least one of the catalysts
(C) being an amine oxide and/or showing at least one amine oxide group.

2. Process according to claim 1, characterized by the fact that the amine oxide shows at least one group of the general formula (I) 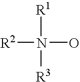
in which R¹, R² and R³ independently of each other can be for a linear or branched hydrocarbon residue with 1 to 22 carbon atoms and the residues R¹, R² and/or R³ can contain part of one or more cyclic residues and/or heteroatoms such as nitrogen or oxygen or sulfur.

3. Process according to claim 2, at least one R¹, R² and R³, independently of each other, standing for ethyl, n- or iso-propyl or n-, iso- or tertiary butyl.

4. Process according to one of the preceding claims, characterized by the fact that the amine oxide shows at least one residue linked to the nitrogen atom with β-hydrogen atom, in particular —CH₂—CH₂—.

5. Process according to one of the preceding claims, characterized by the fact that the amine oxide is selected from the group consisting of triethylamine-N-oxide, N-ethylmorpholine-N-oxide, N-methylmorpholine-N-oxide, diethyloctylamine-N-oxide, dimethylcyclohexylamine-N-oxide, ethyldicyclohexyl-amine-N-oxide, N,N,N′,N′-tetra-ethylbisaminoethyl ether-di-N,N′-oxide, diethycyclo-hexylamine-N-oxide and diethypiperzine-N-oxide.

6. Process according to one of the preceding claims, characterized by the fact that the amine oxide is used at 0.01 to 5% by wt., preferentially at 0.05 to 1% by wt., based on the weight of compounds with reactive hydrogen atoms used.

7. Process according to one of the preceding claims, characterized by the fact that the compounds containing at least two reactive hydrogen atoms consist mainly of a polyether with at least two free hydroxy groups.

8. Process according to one of the preceding claims, characterized by the fact that additionally metal salts of organic compounds can be used as catalysts.

9. Process according to one of the preceding claims, characterized by the fact that besides the amine oxides no tertiary amine catalysts are used.

10. Process according to one of the claims 1 to 7, characterized by the fact that besides the amine oxides no further polyurethane/polyurea catalysts are used.

11. Composition containing the components (A), (B) and (C) according to one of the preceding claims.

12. Composition according to claim 11 containing also one or more tenside compounds as stabilizers, in particular silicones.

13. Use of the composition according to claim 11 or 12 for the production of polyurethane foams, polyurethane adhesives or polyurethane coatings.
